(19) United States
(12) Patent Application Publication
(10) Pub. No.: US 2014/0282867 A1
(43) Pub. Date: Sep. 18, 2014

(54) DEVICE LOCAL REPUTATION SCORE CACHE

(71) Applicant: HEWLETT-PACKARD DEVELOPMENT COMPANY, L.P., Houston, TX (US)

(72) Inventors: Byung Kyu Choi, Ypsilanti, MI (US); Duane E. Mentze, Roseville, CA (US); Jechun Chiu, Cedar Park, TX (US)

(73) Assignee: Hewlett-Packard Development Company, L.P., Houston, TX (US)

(21) Appl. No.: 13/832,330

(22) Filed: Mar. 15, 2013

(51) Int. Cl. H04L 29/06

(52) U.S. Cl. CPC H04L 63/08
USPC 726/3

(57) ABSTRACT

Data can be stored, at a network device, in a device local reputation score cache. The data can include a reputation score for a domain name. The network device can receive a domain name system (DNS) data unit and determine if a domain name in the DNS data unit has a reputation score stored in the device local reputation score cache.

### BACKGROUND

Network security applications may be utilized to enhance the security and/or the performance of a computing network. For example, a network security application may block DNS (domain name system) traffic that is seeking resolution of a domain name, such as those reportedly involved in a malicious activity. Malicious activities can include distributed denial of service attacks or sending spam, for example, among others.

### BRIEF DESCRIPTION OF THE DRAWINGS

FIG. 1 is an example of a computing system according to the present disclosure.

FIG. 2 is flow chart illustrating an example of a method according to the present disclosure.

FIG. 3 illustrates an example of a network device according to the present disclosure.

FIG. 4 illustrates an example of a network device according to the present disclosure.

### DETAILED DESCRIPTION

Network security applications may be utilized to enhance the security and/or the performance of a computing network. Some network security applications can include a DNS controller that is in communication with a number of network devices. The network security application having the DNS controller that is in communication with a number of network devices may be utilized in an inline mode of operation. For example, incoming DNS data units, e.g., packets, frames, etc. received by a network device in communication with the DNS controller, are routed from the network device to the DNS controller. After the DNS controller has received a DNS data unit from the network device, the DNS controller may inspect the data unit. The DNS controller may block the DNS data unit if the domain name in the DNS data unit has a particular reputation score, e.g., a large reputation score. However, if the inspection indicates that the domain name in the DNS data unit has another particular reputation score, e.g., a small reputation score, then the DNS controller may return the DNS data unit to the network device for further forwarding. For the inline mode of operation described above, each DNS data unit that is received by the network device is routed to the DNS controller.

While utilizing the DNS controller in the inline mode of operation can help to block DNS data units having domain names with particular reputation scores, the DNS controller can become overburdened by numerous DNS data units being routed from network devices to the DNS controller. Because the DNS controller can become overburdened, the number of network devices in communication with the DNS controller can be limited.

Examples of the present disclosure include systems, devices, computer-readable media storing instructions, and methods. For instance, such a method can include receiving, at a network device that includes a device local reputation score cache, a domain name system (DNS) data unit; inspecting, at the network device, the DNS data unit to determine a domain name in the DNS data unit; determining, at the network device, if the domain name in the DNS data unit has a reputation score stored in the device local reputation score cache; applying a reputation score action to the DNS data unit if the domain name in the DNS data unit has the reputation score stored in the device local reputation score cache; and forwarding the DNS data unit to a DNS controller if the domain name in the DNS data unit has no reputation score stored in the device local reputation score cache.

Examples of the present disclosure can help provide an improved runtime performance, as compared to some other network security applications. For instance, runtime performance can be determined by a number N of network devices that a DNS controller can serve, e.g., such that the DNS data unit inspection capacity of the DNS controller is not exceeded by receiving DNS data units from N network devices. Examples of the present disclosure can help provide an increased value for N, as compared to some other network security applications.

Improving runtime performance may be described as follows. A network device may be represented by Dᵢ, where i is from 1 to N. DNS inquiry traffic that the Di^{th} network device receives may be represented as Tᵢ. An amount of inquiry traffic from Dᵢ, may be represented as Aᵢ. A workload for inspection of one DNS data unit by the DNS controller may be represented as Cₚᵢ. A current workload for the DNS controller may be represented as C_{curr}, where

$${C}_{curr} = {\sum }_{i = 1}^{N} {A}_{i}$$

and an overall computing capacity of the DNS controller may be represented as Cₘₐₓ. An improved runtime performance, e.g., an increase in N, can be determined under the constraint that C_{curr} does not exceed Cₘₐₓ and values for Cₚᵢ and Cₘₐₓ are constant. As indicated above, C_{curr} can be approximated as a linear function of Aᵢ and therefore a value for N can be increased by decreasing a value for Aᵢ, which would result in improved runtime performance. As discussed herein, examples of the present disclosure can help provide a decreased value for Aᵢ that corresponds to an increased value for N, as compared to some other network security applications.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

FIG. 1 is an example of a computing system 100 according to the present disclosure. FIG. 1 illustrates components of the system 100, which are discussed further herein. The system 100 can include a number N of network devices 102-1, 102-2, . . . , 102-N. The number N of network devices can have various values for differing applications. Each of the network devices 102-1, 102-2, . . . , 102-N can include a device local reputation score cache 104-1, 104-2, . . . , 104-N. The network devices 102-1, 102-2, . . . , 102-N can receive and forward network traffic, e.g., data units, as illustrated by traffic flow 106-1, 106-2, . . . , 106-N. Examples of the present disclosure provide that the network devices 102-1, 102-2, . . . , 102-N can communicate with components of the system 100 and/or components of another system, not illustrated in FIG. 1.

The system 100 can include a Domain Name System (DNS) controller 108. Examples of the present disclosure provide the system 100 can include a plurality of DNS controllers 108. The number of DNS controllers 108 can have various values for differing applications. The DNS controller 108 can include a network local database 110. The DNS controller 108 can be in communication with the network devices 102-1, 102-2, . . . , 102-N by traffic flow 112-1, 112-2, . . . , 112-N. The DNS controller 108 can be in communication with a global database 114 by traffic flow 116. As discussed herein, a network device, e.g. 102-1, 102-2, . . . , 102-N that includes a device local reputation score cache can receive a DNS data unit. The DNS data unit can be inspected to determine a domain name in the DNS data unit. The network device can determine if the domain name in the DNS data unit has a reputation score stored in the device local reputation score cache. A reputation score action can be applied to the DNS data unit if the domain name in the DNS data unit has the reputation score stored in the device local reputation score cache and the DNS data unit can be forwarded to a DNS controller, e.g., DNS controller 108, if the domain name in the DNS data unit has no reputation score stored in the device local reputation score cache.

FIG. 2 is flow chart illustrating an example of a method according to the present disclosure. As illustrated at 218, and as described herein, the method can include receiving, at a network device that includes a device local reputation score cache, a domain name system (DNS) data unit.

The Domain Name System is a hierarchical distributed naming system for entities, e.g., computers, services, or other resources, that are connected to a network, such as the Internet, among others. The DNS can associate information with domain names that are assigned to each of the entities. For example, the DNS can translate domain names into numerical Internet Protocol (IP) addresses, which may be utilized in identifying entities throughout the network. A DNS data unit, e.g., a DNS inquiry data unit such as a DNS packet, can be generated when a client seeks to resolve a domain name into an IP Address.

As mentioned, the DNS data unit can be received by a network device that includes a device local reputation score cache. Examples of the present disclosure provide that the network device can be a switch or a router, among other network devices.

A reputation score can indicate whether or not a domain name is likely to be associated with a malicious activity. For instance, a reputation score that indicates a favorable reputation may indicate that a domain name associated with the favorable reputation is not likely to be associated with a malicious activity. In contrast, a reputation score that indicates an unfavorable reputation may indicate that a domain name associated with the unfavorable reputation is likely to be associated with a malicious activity. Examples of the present disclosure provide that the reputation score can be based upon a rating scale, which may be referred to as a ranking scale. For instance, the reputation score can be based upon a rating scale having a range from 0 to 1, a range from 1 to 10, a range from 0% to 100%, a range from A+ to F−, e.g., grades, or combinations thereof, among other rating scales. Some other rating scales include, but are not limited to, a star rating system, e.g., where a rating having more stars is more positive than a rating having fewer stars, or a color rating system, e.g., where red indicates a unfavorable reputation, yellow indicates an neutral reputation, and green indicates a favorable reputation.

At 220, the method can include inspecting the DNS data unit, at the network device, to determine a domain name in the DNS data unit. At 222, the method can include determining, at the network device, if the domain name in the DNS data unit has a reputation score stored in the device local reputation score cache. For example, from the inspected DNS data unit, the determined domain name in the DNS data unit can be compared to domain names stored in the device local reputation score cache. If the determined domain name in the DNS data unit is matched to a domain name stored in the device local reputation score cache, then a reputation score associated with the domain name stored in the device local reputation score cache may be associated with the determined domain name in the DNS data unit. However, the determined domain name in the DNS data unit may not be matched to a domain name stored in the device local reputation score cache, in which case a reputation score stored in the device local reputation score cache may not be associated with the determined domain name in the DNS data unit.

Examples of the present disclosure provide that the device local reputation score cache can utilize a structure for string matching and/or bit matching. For instance, the device local reputation score cache can utilize a radix tree structure, among other structures. As an example, domain names can be represented in string form, e.g., a collection of American Standard Code for Information Interchange (ASCII) characters and a string terminator, such as a null character. Also for example, a node of the radix tree may be reduced to hold one bit of information. Examples of the present disclosure provide that the method can include updating device local reputation score cache with data stored in the network local database, as discussed herein.

At 224, the method can include applying a reputation score action to the DNS data unit if the domain name in the DNS data unit has the reputation score stored in the device local reputation score cache. For instance, if the domain name in the DNS data unit has a reputation score stored in the device local reputation score cache that reputation score, e.g., a first reputation score, may be a favorable reputation score. Because the domain name is associated with the favorable reputation score, it is not likely that the domain name is associated with a malicious activity. Therefore, the reputation score action applied to the DNS data unit may be a favorable reputation score action. For example, the reputation score action applied to the DNS data unit may be forwarding the DNS data unit to a next hop.

However, if the domain name in the DNS data unit has a reputation score stored in the device local reputation score cache that reputation score, e.g. a second reputation score, may be an unfavorable reputation score. Because the domain name is associated with the unfavorable reputation score, it may be likely that the domain name is associated with a malicious activity. Therefore, the reputation score action applied to the DNS data unit may be an unfavorable reputation score action. For example, the reputation score action applied to the DNS data unit may be an obstructing action. Examples of obstructing actions include a blocking action, a rate limiting action, and a no such host reply action, among other obstructing actions.

A blocking action can prevent the DNS data unit from a next hop. For example, the blocking action can drop the DNS data unit in response to the domain name being associated with the unfavorable reputation score.

A rate limiting action can forward the DNS data unit to a next hop. However, when a rate limiting action is applied to the DNS data unit a bandwidth restriction is assigned to traffic associated with the DNS data unit. For example, the rate limiting action may establish a threshold, e.g., 10000 data units per second, however, a value for the threshold can vary for differing applications. Thereafter, if the port receives more than 10000 data units in any one-second interval, the network device forwards the excess fragments at a lowered priority level.

A no such host reply action can prevent the DNS data unit from a next hop. Additionally, the no such host reply may help reduce subsequent traffic because the reply indicates that the associated domain name does not exist anymore or is disabled.

As mentioned, examples of the present disclosure can help provide an improved runtime performance, as compared to some other network security applications, because each DNS data unit that is received by the network device is not routed to the DNS controller. For example, DNS data units received by the network device to which a reputation score action is applied, as discussed herein, are not routed to the DNS controller.

At 226, the method can include forwarding the DNS data unit to a DNS controller if the domain name in the DNS data unit has no reputation score stored in the device local reputation score cache. The DNS controller may be in communication with a number of network devices. Examples of the present disclosure provide that the DNS controller can communicate with the number of network devices via a communications protocol, such as OpenFlow, among other communications protocols. The DNS controller may be utilized to surveil and/or maintain at least a part of a network, such as a multi-layer switched and routed network, among other networks.

The DNS controller can include a network local database. The network local database can include reputation scores associated with domain names. The network local database can be updated, e.g., constantly or periodically, from a global database. The global database can be a centralized database where reputation scores associated with domain names are consolidated after being collected, e.g., by one or more entities. Examples of the present disclosure provide that the global database is a dynamically changing database, e.g., the global database is updated in real time.

Examples of the present disclosure provide that the DNS controller can inspect the DNS data unit, which was forwarded from the network device, to determine a domain name in the DNS data unit. The DNS controller can determine a reputation score stored in the network local database associated with the domain name in the DNS data unit. Thereafter, the DNS controller can apply a reputation score action to the DNS data unit. For instance, if the domain name in the DNS data unit has a reputation score stored in the network local database, that reputation score may be a favorable reputation score. Because the domain name is associated with the favorable reputation score, it is not likely that the domain name is associated with a malicious activity. Therefore, the reputation score action applied to the DNS data unit may be a favorable reputation score action. For example, the reputation score action applied to the DNS data unit may be forwarding the DNS data unit to a network device, e.g., the network device that forwarded the DNS data unit to the DNS controller, such that the DNS data unit can be forwarded to a next hop. As such, examples of the present disclosure provide that the method can include receiving the DNS data unit, at the network device, from the DNS controller if the domain name in the DNS data unit has a first reputation score stored in a network local database. However, if the domain name in the DNS data unit has a reputation score stored in the network local database, that reputation score may be an unfavorable reputation score. Because the domain name is associated with the unfavorable reputation score, it may be likely that the domain name is associated with a malicious activity. Therefore, the reputation score action applied to the DNS data unit may be an unfavorable reputation score action. For example, the reputation score action applied to the DNS data unit may be an obstructing action, as discussed herein.

FIG. 3 illustrates an example of a network device 302 according to the present disclosure. The network device 302 can be analogous to the network device, e.g. network device 102-1, 102-2, . . . , 102-N, illustrated in FIG. 1. The network device 302 can utilize software, hardware, firmware, and/or logic to perform a number of functions.

The network device 302 can be a combination of hardware and program instructions configured to perform a number of functions, e.g., actions. The hardware, for example, can include a number of processing resources 330 and a number of memory resources 332, such as a machine-readable medium (MRM) or other memory resources 332. The memory resources can be internal and/or external to the network device 302, e.g., the network device 302 can include internal memory resources and have access to external memory resources. The program instructions, e.g., machine-readable instructions (MRI)) can include instructions stored on the MRM to implement a particular function, e.g., an action such as storing, at the network device, data in a device local reputation score cache that includes a reputation score for a domain name. The set of MRI can be executable by one or more of the processing resources 330. The memory resources 332 can be coupled to the network controller 302 in a wired and/or wireless manner. For example, the memory resources 332 can be an internal memory, a portable memory, a portable disk, and/or a memory associated with another resource, e.g., enabling MRI to be transferred and/or executed across a network such as the Internet.

Memory resources 332 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of machine-readable media.

The processing resources 330 can be coupled to the memory resources 332 via a communication path 334. The communication path 334 can be local or remote to the network device 302. Examples of a local communication path 334 can include an electronic bus internal to a machine, where the memory resources 332 are in communication with the processing resources 330 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 334 can be such that the memory resources 332 are remote from the processing resources 330, such as in a network connection between the memory resources 332 and the processing resources 330. That is, the communication path 334 can be a network connection. Examples of such a network connection can include local area network (LAN), wide area network (WAN), personal area network (PAN), and the Internet, among others.

As shown in FIG. 3, the MRI stored in the memory resources 332 can be segmented into a number of modules 336, 338, 340 that when executed by the processing resources 330 can perform a number of functions. As used herein a module includes a set of instructions included to perform a particular task or action. The number of modules 336, 338, 340 can be sub-modules of other modules. For example, the store data module 336 can be a sub-module of the receive data unit module 338 and/or the store data module 336 and the receive data unit module 338 can be contained within a single module. Furthermore, the number of modules 336, 338, 340 can comprise individual modules separate and distinct from one another. Examples are not limited to the specific modules 336, 338, 340 illustrated in FIG. 3.

The network device 302 can include a store data module 336, which can store, at the network device 302, data in a device local reputation score cache that includes a reputation score for a domain name, as discussed herein.

Examples of the present disclosure provide that the instructions can be executed to load a portion of a network local database to store in the device local reputation score cache. For instance, a portion of the network local database to be utilized by the device local reputation score cache, e.g., a portion containing reputation score for domain names, can be identified and that portion of the network local database can be stored in the device local reputation score cache. Examples of the present disclosure provide that the network local database can store more information, e.g., has a greater storage capacity, than the device local reputation score cache. For instance, the device local reputation score cache can be a subset of the network local database.

Examples of the present disclosure provide that the instructions can be executed to store data in the device local reputation score cache that includes a reputation score for the domain name in the DNS data unit received at the network device. For instance, data, e.g., a reputation score, can be incrementally added to the device local reputation score cache, such as when a DNS data unit having a reputation score that has not been previously stored in the device local reputation score cache is received by the network device.

Examples of the present disclosure provide that the instructions can be executed to remove data from the device local reputation score cache. For instance, data, e.g., a reputation score, can be removed from the device local reputation score cache following a predetermined time interval. The predetermined time interval can have various values for differing applications.

Examples of the present disclosure provide that the instructions can be executed to establish a threshold number of reputation scores in the device local reputation score cache. For instance, a threshold number of reputation scores, e.g., 50, 75, 100, 200, or another threshold number, can be established in the device local reputation score cache such that a number of reputation scores in the device local reputation score cache does not exceed the threshold number. As an example, when a threshold number of reputation scores is established in the device local reputation score cache and the cache is currently storing the threshold number of reputation scores, for each reputation score that is newly added to the device local reputation score cache a previously stored reputation score is removed from the device local reputation score cache. Examples of the present disclosure provide that the oldest previously stored reputation score can be removed from the device local reputation score cache when a newly added reputation score is stored and the cache is storing the threshold number of reputation scores. The threshold number of reputation scores can have various values for differing applications.

The network device 302 can include a receive data unit module 338, which can receive, at the network device 302, a DNS data unit. The network device 302 can include a reputation score module 340 which can determine, at the network device 302, if a domain name in the DNS data unit has a reputation score stored in the device local reputation score cache. Examples of the present disclosure provide that the instructions can be executed to apply a reputation score action to the DNS data unit if the domain name in the DNS data unit has the reputation score stored in the device local reputation score cache. Examples of the present disclosure provide that the instructions can be executed to forward the DNS data unit to a DNS controller if the domain name in the DNS data unit has no reputation score stored in the device local reputation score cache.

FIG. 4 illustrates an example of a network device 402 according to the present disclosure. The network device 402 can be analogous to the network device, e.g. network device 102-1, 102-2, . . . , 102-N, illustrated in FIG. 1. The network device 402 can include a network chip 442. While FIG. 4 illustrates a single network chip, examples of the present disclosure are not so limited. The network device 402 can include a network port, e.g., a number of network ports 444-1, 444-2, 444-3, . . . , 444-M, for receiving and transmitting data units therefrom. M can have differing values for various applications. The network device 402 can include logic circuitry, e.g., hardware, which can execute instructions and/or logic. For instance, the network device 402 can include an application specific integrated circuit (ASIC) 446. Examples of the present disclosure provide that the network device 402 can include a plurality of ASICs. Examples of the present disclosure provide that the network device 402 can receive a domain name system (DNS) data unit that includes a device local reputation score cache, inspect the DNS data unit to determine a domain name in the DNS data unit; determine if the domain name in the DNS data unit has a reputation score stored in the device local reputation score cache, apply a reputation score action to the DNS data unit if the domain name in the DNS data unit has the reputation score stored in the device local reputation score cache, and forward the DNS data unit to a DNS controller if the domain name in the DNS data unit has no reputation score stored in the device local reputation score cache, as discussed herein. Examples of the present discourse provide that the network device 402 can establish a threshold number of entries in the device local database, as discussed herein. The network device 402 can be deployed in a wireless network, among other networks.

The methods, systems, and devices described herein may be implemented in digital electronic circuitry or computer hardware, for example, by executing instructions stored in computer-readable storage media. Apparatuses implementing these techniques may include appropriate input and output devices, a computer processor, and/or a tangible computer-readable storage medium storing instructions for execution by a processor.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

As used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed is:

1. A non-transitory computer-readable medium storing a set of instructions executable by a processing resource to:
store, at a network device, data in a device local reputation score cache that includes a reputation score for a domain name;
receive, at the network device, a domain name system (DNS) data unit; and
determine, at the network device, if a domain name in the DNS data unit has a reputation score stored in the device local reputation score cache.

2. The medium of claim 1, further storing instructions executable to:
load a portion of a network local database to store in the device local reputation score cache.

3. The medium of claim 1, further storing instructions executable to:
store data in the device local reputation score cache that includes a reputation score for the domain name in the DNS data unit received at the network device.

4. The medium of claim 1, further storing instructions executable to:
remove data from the device local reputation score cache following a predetermined time interval.

5. A computing-device implemented method, comprising:
receiving, at a network device that includes a device local reputation score cache, a domain name system (DNS) data unit;
inspecting, at the network device, the DNS data unit to determine a domain name in the DNS data unit;
determining, at the network device, if the domain name in the DNS data unit has a reputation score stored in the device local reputation score cache;
applying a reputation score action to the DNS data unit if the domain name in the DNS data unit has the reputation score stored in the device local reputation score cache; and
forwarding the DNS data unit to a DNS controller if the domain name in the DNS data unit has no reputation score stored in the device local reputation score cache.

6. The method of claim 5, wherein applying the reputation score action includes applying a first reputation score action to the DNS data unit if the domain name in the DNS data unit has a first reputation score stored in the device local reputation score cache; and applying a second reputation score action to the DNS data unit if the domain name in the DNS data unit has a second reputation score stored in the device local reputation score cache.

7. The method of claim 6, wherein the first reputation score action comprises forwarding the DNS data unit to a next hop.

8. The method of claim 6, wherein the second reputation score action comprises an obstructing action.

9. The method of claim 8, wherein the obstructing action is chosen from the group of a blocking action, a rate limiting action, and a no such host reply action.

10. The method of claim 5, wherein the device local reputation score cache utilizes a radix tree structure.

11. The method of claim 5, wherein the method further comprises:
receiving the DNS data unit, at the network device, from the DNS controller if the domain name in the DNS data unit has a first reputation score stored in a network local database.

12. The method of claim 11, wherein the method further comprises:
updating the device local reputation score cache with data stored in the network local database.

13. A network device, comprising:
a network chip including logic, embedded in an application specific integrated circuit, and a network pod for the device for receiving and transmitting data units therefrom, the network chip to:
receive a domain name system (DNS) data unit that includes a device local reputation score cache;
inspect the DNS data unit to determine a domain name in the DNS data unit;
determine if the domain name in the DNS data unit has a reputation score stored in the device local reputation score cache;
apply a reputation score action to the DNS data unit if the domain name in the DNS data unit has the reputation score stored in the device local reputation score cache; and
forward the DNS data unit to a DNS controller if the domain name in the DNS data unit has no reputation score stored in the device local reputation score cache.

14. The network device of claim 13, including the network chip to:
establish a threshold number of entries in the device local database.

15. The network device of claim 13, wherein the network device is deployed in a wireless network.
